(19) United States
(12) Patent Application Publication
(10) Pub. No.: US 2021/0129227 A1
(43) Pub. Date: May 6, 2021

(54) APPARATUS AND METHOD FOR CREATING METAL MATRIX COMPOSITE THREE-DIMENSIONAL OBJECTS

(71) Applicant: Dyze Design inc., Lemoyne (CA)

(72) Inventors: Philippe CARRIER, Montreal (CA); Maxence GELINAS-GUY, Boucherville (CA)

(21) Appl. No.: 16/973,956

(22) PCT Filed: Jul. 30, 2019
(86) PCT No.: PCT/CA2019/051040

§ 371 Date: Dec. 10, 2020

Related U.S. Application Data
(60) Provisional application No. 62/712,671, filed on Jul. 31, 2018.

(51) Int. Cl. B22F 12/53; B22F 10/22; B22F 12/90; B33Y 30/00; B22D 23/00

(52) U.S. Cl. CPC B22F 12/53; B22F 10/22; B22D 23/003; B33Y 30/00; B22F 12/90

(57) ABSTRACT

An apparatus for fabricating a three-dimensional object from deposition of layers made of reinforcement material and of extrudable material is described. The apparatus comprises: an extrusion assembly comprising a feeder having a longitudinal hole adapted for conveying the reinforcement material and wherein the feeder is adapted for conveying the extrudable material at least partly outside the longitudinal hole; a reinforcement material driving mechanism for driving the reinforcement material to the extrusion assembly; and a building platform on which is made the deposition of layers of reinforcement material and of extrudable material.

### CROSS-REFERENCE TO RELATED APPLICATION

This application claims priority from U.S. provisional patent application 62/712,671 filed Jul. 31, 2018, the specification of which is hereby incorporated herein by reference in its entirety.

### BACKGROUND

### (a) Field

The subject matter disclosed generally relates to three-dimensional manufacturing apparatuses. More particularly, the subject matter disclosed relates to three-dimensional manufacturing apparatuses using deposition of layers of material to manufacture a three-dimensional object.

### (b) Related Prior Art

Fused filament fabrication and the like are techniques for fabricating three-dimensional objects from a thermoplastic or similar material. Machines using this technique can fabricate three-dimensional objects by depositing lines of material to build in layers summing up to the three-dimensional object. While these polymer-based techniques have been continuously improved over the years, the physical principles applicable to polymer-based systems still have drawbacks, such as deficiencies in operations with metal-based material, and regarding limitations in the structures and/or strength of the three-dimensional objects fabricated therewith.

There is therefore a need for improvement with three-dimensional manufacturing apparatuses, which are commonly called 3D printers, Deposition Manufacturing Devices, or alike, that would respond to drawbacks present in existing apparatuses.

### SUMMARY

According to an embodiment, there is provided an apparatus for fabricating a three-dimensional object from deposition of layers made of reinforcement material and of extrudable material, wherein the apparatus comprises: an extrusion assembly comprising a feeder having a longitudinal hole adapted for conveying the reinforcement material and wherein the feeder is adapted for conveying the extrudable material at least partly outside the longitudinal hole; a reinforcement material driving mechanism for driving the reinforcement material to the extrusion assembly; and a building platform on which is made the deposition of layers of reinforcement material and of extrudable material.

According to an aspect, the extrusion assembly further comprises barrel comprising an inner bore, an upstream end and a downstream end; and a screw rotatably mounted within the inner bore, comprising threads and a longitudinal hole, wherein the screw is adapted for: conveying, through the longitudinal hole, the reinforcement material toward the downstream end; and conveying, by the threads, the extrudable material located between the screw and the inner bore toward the downstream end.

According to an aspect, the apparatus further comprises a sensor mounted to the extrusion assembly, the sensor measuring forces exerted by the screw for establishing at least one of a) extrusion force and b) extrusion pressure applied by the apparatus over the extrudable material.

According to an aspect, the extrusion assembly further comprises a nozzle, mounted to the downstream end of the barrel, comprising an outlet, wherein the nozzle is adapted for concurrently dispensing, through the outlet, the extrudable material and the reinforcement material conveyed by the screw.

According to an aspect, wherein the reinforcement material driving mechanism comprises rollers between which the reinforcement material is introduced wherein at least one of the rollers is motorized hence driving the reinforcement material to the extrusion assembly.

According to an aspect, the apparatus further comprises a cutting component cutting the reinforcement material in length upstream from the extrusion assembly.

According to an aspect, the apparatus further comprises an extrusion head comprising an inlet, an outlet and a channel fluidly connecting the inlet to the outlet whereby, when a flow of extrudable material is provided, the flow of extrudable material travels in a downstream direction.

According to an aspect, the extrusion head further comprises a plug located in the channel, the plug operable in either one of: a) a no-flow position blocking the flow of material between the inlet and the outlet of the extrusion head; and b) another position allowing the flow of material from the inlet to the outlet of the extrusion head.

According to an aspect, the extrusion head further comprises a biasing means pushing the plug against the downstream direction, wherein a pressure against the plug greater than a no-flow pressure counteracts against the biasing means resulting in the plug leaving the no-flow position and thereby allowing the flow of material to reach the outlet of the extrusion head.

According to an aspect, the extrusion head is mounted to the extrusion assembly; and wherein the plug has a surface of a spherical shape which is pushed by the biasing means toward the extrusion assembly.

According to an embodiment, there is provided an extrusion assembly to be mounted to an apparatus adapted for making three-dimensional physical objects by depositing a plurality of layers of extrudable material and reinforcement material, the extrusion assembly comprising: a barrel comprising an inner bore, an upstream end and a downstream end; a screw rotatably mounted within the inner bore, comprising threads and a longitudinal hole, wherein the screw is adapted for: conveying, through the longitudinal hole, the reinforcement material toward the downstream end; and conveying, by the threads, the extrudable material located between the screw and the inner bore toward the downstream end; and a nozzle, mounted to the downstream end of the barrel, comprising an outlet, wherein the nozzle is adapted for concurrently dispensing, through the outlet, the extrudable material and the reinforcement material conveyed by the screw.

According to an aspect, the screw has an axis, and wherein the longitudinal hole is co-axial with the screw axis

According to an aspect, the screw has a length, and wherein the longitudinal hole extends over the length of the screw.

According to an aspect, the screw has a screw length and a threaded length, and wherein the threaded length is smaller than the screw length.

According to an aspect, the screw has an axis, a threaded length and a major diameter measured based on radial extent of the threads from the axis, and wherein the major diameter is constant over the threaded length.

According to an aspect, the screw has a threaded length, and wherein the threads have a thread angle that is constant over the threaded length.

According to an aspect, the screw has an axis, a threaded length, a shaft and a minor diameter measured based on radial extent of the shaft from the axis, and wherein the minor diameter increases over the threaded length as the shaft extends downstream.

According to an aspect, the screw has an axis, a shaft, a threaded length, and defines, in combination with the inner bore, a plurality of conveying spaces of an area on any plan comprising the axis; and wherein the area of a first one of the conveying spaces is smaller than the area of a second one of the conveying spaces with the first one of the conveying spaces being downstream to the second one of the conveying spaces.

According to an aspect, the screw further comprises a conical head about the downstream end.

According to an aspect, the screw has a threaded length and a shaft having a maximum diameter over its threaded length, wherein the conical head has a maximum diameter, and wherein the maximum diameter of the conical head is smaller than the maximum diameter of the shaft.

According to an aspect, the screw comprises a tangential face and is driven via the tangential face.

According to an embodiment, there is provided an extrusion assembly to be mounted to an apparatus adapted for making three-dimensional physical objects by depositing a plurality of layers of extrudable material and reinforcement material, the extrusion assembly comprising: a barrel comprising an inner bore, an upstream end and a downstream end; a feeder mounted, at least in part, within the inner bore and comprising a longitudinal hole, wherein the feeder is adapted for: conveying, through the longitudinal hole, the reinforcement material toward the downstream end; and conveying the extrudable material, which is within the inner bore excluding the longitudinal hole, toward the downstream end; and a nozzle, mounted to the downstream end of the barrel, comprising an outlet, wherein the nozzle is adapted for concurrently dispensing, through the outlet, the extrudable material and the reinforcement material conveyed by the feeder.

According to an embodiment, there is provided an apparatus for fabricating a three-dimensional object from deposition of layers made of reinforcement material and of extrudable material, wherein the apparatus comprises: an extrusion assembly comprising a feeder having a longitudinal hole adapted for conveying the reinforcement material and wherein the feeder is adapted for conveying the extrudable material outside the longitudinal hole; a frame to which is mounted to the extrusion assembly; a building platform on which is made the depositions of layers of reinforcement material and of extrudable material; a reinforcement material driving mechanism for driving the reinforcement material to the extrusion assembly; and a hopper in fluid communication with the extrusion assembly and storing extrudable material.

According to an embodiment, there is provided an apparatus for fabricating a three-dimensional object using extrudable material, the apparatus comprising: a barrel comprising an inner bore, an upstream end and a downstream end; a screw rotatably mounted within the inner bore, comprising threads adapted for conveying the extrudable material located between the screw and the inner bore toward the downstream end; and a sensor functionally mounted to the screw, the sensor measuring forces exerted by the screw for establishing at least one of: a) extrusion force applied by the apparatus over the extrudable material; and b) extrusion pressure applied by the apparatus over the extrudable material.

According to an aspect, the apparatus comprises a frame; wherein the screw comprises an upstream end and a downstream end; wherein the screw is mounted to the frame at the upstream end; and wherein the sensor is mounted to the upstream end and to the frame.

According to an embodiment, there is provided extrusion head for an apparatus for fabricating three-dimensional objects using a flow of extrudable material, the extrusion head comprising: a body comprising an inlet, a nozzle outlet and a channel fluidly connecting the nozzle outlet to the inlet for the flow of extrudable material to travel in a downstream direction from the inlet to the nozzle outlet; a plug located in the channel, the plug operable in a no-flow position blocking the flow of material between the inlet to the nozzle outlet and another position allowing the flow of material from inlet to the nozzle outlet; and a biasing means pushing against the plug against the downstream direction, wherein a pressure against the plug higher than a no-flow pressure results in the plug leaving the no-flow position and thereby allow the flow of material to reach the nozzle outlet.

According to an aspect, the extrusion head is mounted to an extrusion assembly; and wherein the plug has a surface of a spherical shape which is pushed by the biasing means toward the extrusion assembly in a biasing direction to either block the passage of the extrudable material or to convey the extrudable material depending on the pressure applied by the extrudable material in a direction opposite the biasing direction.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a partial cross-section perspective view of a three-dimensional manufacturing apparatus according to the prior art;

FIG. 2 is a cross-section elevation view of an extrusion assembly for the three-dimensional manufacturing apparatus of FIG. 1 in accordance with a first embodiment;

FIG. 3 is a cross-section elevation view of an extrusion assembly for the three-dimensional manufacturing apparatus of FIG. 1 in accordance with another embodiment;

FIG. 4 is a cross-section elevation view of an extrusion head of a three-dimensional manufacturing apparatus in accordance with an embodiment;

FIG. 5 is a cross-section elevation partial view of the other extremity of the conveyor screw of FIGS. 2 and 3 in accordance with an embodiment;

FIG. 6 is a side elevation view of a portion of the three-dimensional manufacturing apparatus using a reinforcing material about the upstream end of the conveyor screw;

FIGS. 7A and 7B are cross-section elevation views of an extrusion head of a three-dimensional manufacturing apparatus in accordance with an embodiment, wherein FIG. 7A and FIG. 7B depict respectively configurations corresponding to a blocked flow and to an open flow; and

FIG. 8 is a side elevation view of the conveyor screw in accordance with an embodiment.

It will be noted that throughout the appended drawings, like features are identified by like reference numerals.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein.

With respect to the present description, references to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first”, “second”, “top”, “bottom”, “above”, “below”, and the like, are words of convenience and are not to be construed as limiting terms.

The following description emphasizes three-dimensional manufacturing apparatuses using fused deposition modeling or similar techniques where material is extruded in a layered series of two-dimensional patterns as “roads,” “paths” or the like to form a three-dimensional object from a digital model. It will be understood, however, that numerous additive fabrication techniques are known in the art including without limitation multijet printing, stereolithography, Digital Light Processor (“DLP”) three-dimensional printing, selective laser sintering, and so forth. Such techniques may benefit from the systems and methods described below, and all such printing/manufacturing technologies are intended to fall within the scope of this disclosure, and within the scope of terms such as “printer”, “three-dimensional printer”, “fabrication system”, and so forth, unless a more specific meaning is explicitly provided or otherwise clear from the context.

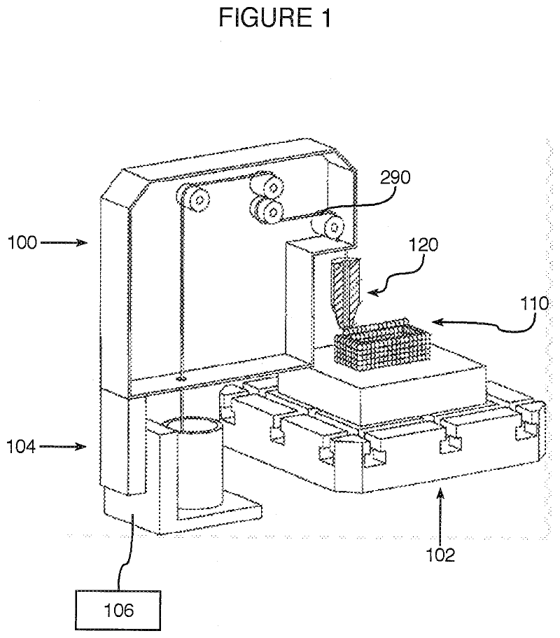

Referring to FIG. 1, a person skilled in the art would recognize that a three-dimensional manufacturing apparatus 100 includes a build platform 102, an extrusion assembly 120, an X-Y-Z positioning assembly 104, and a controller 106 that controls the previous components to fabricate a three-dimensional object 110 within a working volume of the three-dimensional manufacturing apparatus 100. More specifically, the present description concerns the extrusion assembly 120 of the three-dimensional manufacturing apparatus 100. The extrusion assembly 120 transforms the extrudable material 290 (shown according to a specific non-limiting embodiment where the extrudable material 290 consists of a continuous strip or film fed to the extrusion assembly 120) from a first solid state into a second extrudable state in which the extrudable material 290 is to be deposited in series of superposed layers of two-dimensional patterns to manufacture the three-dimensional object 110.

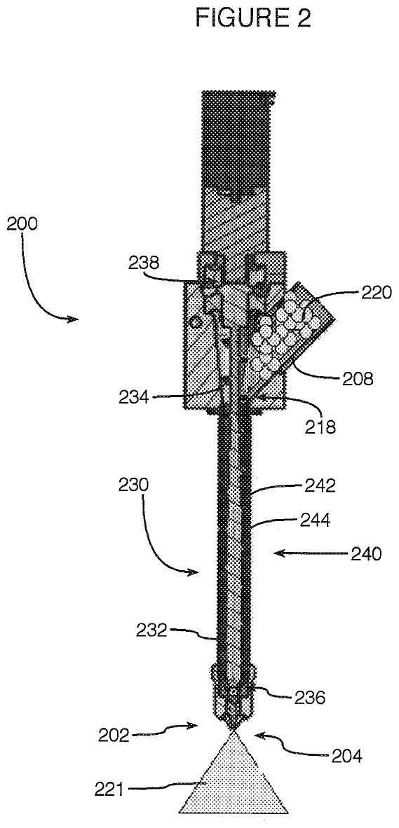

Now referring to FIG. 2, there is shown a cross-section schematic view of an extrusion assembly 200 adapted for extruding extrudable material 220. The extrusion assembly 200 may be a modular extrusion assembly that can be removably and replaceably coupled to a three-dimensional manufacturing apparatus 100, or alternatively to similar devices and printers as the ones described above. Although not described, the present document covers an extrusion assembly 200 mounted according to various techniques so that the extrusion assembly 200 is mounted in a modular fashion in cooperation with other components of the three-dimensional manufacturing apparatus 100. These techniques are believed to be part of the common knowledge of a person skilled in the present art and the selection of one technique over the other is a choice of design. Thus, it will be understood that that any technique capable of fulfilling requirements associated with the mounting of the extrusion assembly 200 respecting the requirements regarding displacement of the extrusion assembly 200 when in operation and capable of resisting to extrusion-related forces are believed to be suitably in relation of the present extrusion assembly 200. The extrusion assembly 200 comprises an extrusion head 202 with a nozzle 204 designed to extrude extrudable material 220 and eject it in an extrudable state 221.

The extrusion assembly 200 comprises an extrusion head 202 with a nozzle 204 designed to extrude extrudable material 220 in an extrudable state. The extrusion assembly 200 further comprises a bucket compartment 208, e.g., a hopper, where extrudable material 220 in solid state is provided, which, according to an embodiment, comprises the extrudable material 220 in powder, pellet or bead format. The extrusion assembly 200 further comprises a heating component 240 capable of heating the extrudable material 220 to be conveyed to the nozzle 204 to an extrusion temperature. The extrusion assembly 200 further comprises a conveying means 230 conveying the extrudable material 220 from the bucket compartment 208 to the heating component 240 and to the extrusion head 202. The extrusion assembly 200 is adapted to be fed with a variety of materials in the form of beads, pellets and powder. The bucket compartment 208 and its connection to the conveyor screw 232 are adapted for these varieties of material to travel without clogging. The nature of the material to be fed to the conveyor screw 232 may be a unique material. According to an embodiment, the fed material (aka the base material) is a mix of materials; e.g., metal and binding element which can be softened through the apparatus and solidifies once extruded. The process produces a “green” part which will be later debinded and sintered by conventional process. The heating component 240 is adapted to work at a temperature required by the mix of materials to be extrudable, while the mix of materials is selected in part on the temperature(s) at which the components of the mix may be processed by the extrusion assembly 200.

According to embodiments, the bucket compartment 208 may also be called or comprise a hopper, with the hopper being in fluid communication with the extrusion assembly 200 in order to convey extrudable material 220 in the form of beads, pellets or powder contained in the hopper from the hopper in the extrusion assembly 200.

According to embodiments, the hopper may be located close to the extrusion assembly 200 as depicted on FIG. 2. According to embodiments, the hopper may be located remote from the extrusion assembly 200, with the presence of a conduit or a conveying means in fluid communication between connecting them. The extrudable material 220 is conveyed in the conduit or the conveying means from the hopper either based on pressure gradient between the hopper and the extrusion assembly 200, based on natural flow operating according to gravity, and/or according to mechanical forces exerted over the extrudable material.

According to embodiments, used materials may comprise a single one or a mix of materials comprising thermoplastics, such as polyethylene, polypropylene, polylacticacid, polycarbonate, Acrylonitrile butadiene styrene, and Polyether ether ketone. Material may comprise a mix from different powders (metals, ceramics) that can be used when mixed with binders such as polymers, wax, and oil. Metal injection molding feedstock can be used such as carbon steel (1008, 1010, 1070, 1080), stainless steel (15-5PH, 17-4PH, 303, 304, 316, 410), alloy steel (4120, 4130, 4340), and other metals and alloys such as aluminum, copper, cobalt, titanium and tungsten. Ryer Inc. [http://www.ryerinc.com/index.html] is a very popular supplier of such feedstock. Ceramics can be used as a feedstock such as alumina (Al2O3) and zirconia (ZrO2). Inmatec [http://www.inmatec-gmbh.com/cms/index.php/en/] is a well-known German supplier of that latter feedstock. The heating component can reach 500° C., currently limited by the temperature sensor.

According to an embodiment, the conveying means 230 comprises a conveyor screw 232, aka a screw 232, mounted coaxially to the heating component 240, and more specifically passing through the heating component 240. Accordingly, the extrudable material 220 is forced by the threads 234 of the conveyor screw 232 inside the heating component 240 in the downstream direction towards the extrusion head 202. The extrudable material 220 is more specifically conveyed in the space between the surface of the conveyor screw 232 and the interior wall 242 of the heating component 240 wherein it is gradually heated to the desired temperature.

It is worth to note that the heating component 240 described hereinbefore comprises a barrel 356 comprising an inner bore 358, an upstream end 382 and a downstream end 384 fluidly connected to the nozzle 204. The inner bore 358 provides room for the operation of the conveyor screw 232 and the displacement of the extrudable material towards the nozzle 204.

According to embodiments, the barrel 356 may be able to generate heat, resulting in the heating component 240 described herein. In other embodiments, heating may be applied over the barrel 356 by a distinct heating component, with the barrel 356 being thereby a passive component providing the room described above for travel of the extrudable material 220 to the downstream end 384 and thermal conductivity between a heating source and the extrudable material 220 travelling in the room for the extrudable material 220 to change phase of during its course in the barrel 356 from a solid state to a liquified extrudable state.

According to embodiments, the heating component 240 heats the extrudable material 220 over the whole threaded section (as described later) of the conveyor screw 232 (or conveyor screw 332, as described later) or over a smaller length of the course of the extrudable material 220 along the threaded section of the conveyor screw 232/323.

The conveyor screw 232 comprises an extrusion end 236, aka downstream end 236, close, about or abutting the nozzle 204 and another end 238, aka the upstream end 238, above the feeding zone 218 where the bucket compartment 208 connects with the interior space about the conveyor screw 232. The conveyor screw 232 is driven above the feeding zone 218, at the upstream end 238.

Accordingly, the bucket compartment 208, the space between the interior wall 242 of the heating component 240 and the nozzle 204 define a passage 244 where the extrudable material 220 is forcedly conveyed downstream-ward and wherein the extrudable material 220 changes phase from its feeding phase in the feeding zone 218 to it extrudable phase in the zone about the nozzle 204 to be ready to be extruded therethrough.

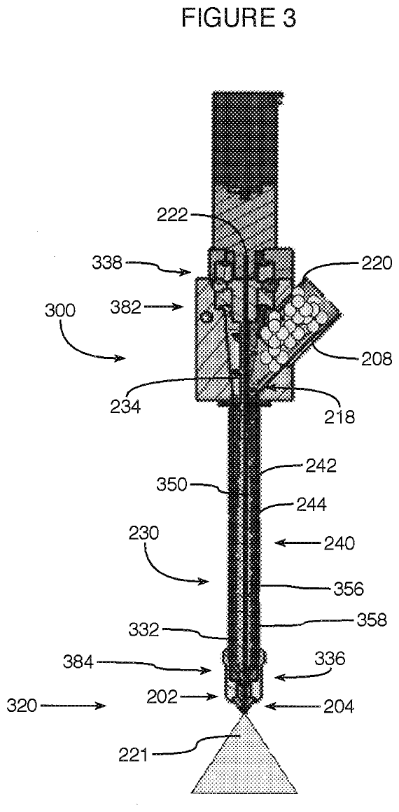

Now referring to FIG. 3, there is shown a cross-section view of an extrusion assembly 300 according to another embodiment. The extrusion assembly 300 comprises a conveyor screw 332 having similar characteristics as the conveyor screw 232 with respect to at least some of its external characteristics. The conveyor screw 332 further comprises a conduit 350, aka a longitudinal hole 350, extending along its axis. The conduit 350 goes through the length of the conveyor screw 332 from its upstream end 338 to the downstream end 336. The conduit 350 is adapted to provide a passage for reinforcement material 222, such as metal such as steel or tungsten in a wire format, such as glass and carbon in a fiber, ribbon or wire format, or polymer such as Kevlar in a similar format. The reinforcement material 222 is to be mixed with and extruded along with the extrudable material 220. The extrusion assembly 300 further comprises a cutting component 320 located either upstream from the conveyor screw 332 or at the end of the nozzle 204, where for example a shearing mechanism is used for cutting the reinforcement material 222 in lengths, and wherein the lengths are designed according to the path along which the extrudable material 220 will be laid down in order to fabricate a three-dimensional object 110.

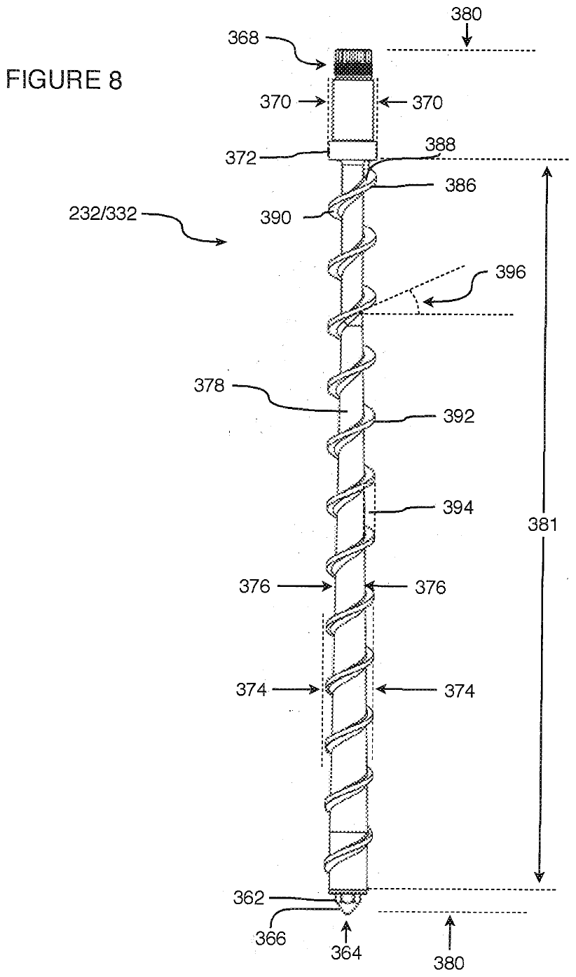

Referring now additionally to FIG. 8, the conveyor screw 232/332 operates mostly within the inner bore 358 of the barrel 356; the threads 386 being adapted to push the extrudable material 220 downstream-ward thus towards the downstream end 384. The conveyor screw 232/332 comprises an upstream end 382 distant from the downstream end 384 wherein the conveyor screw 232/332 is driven directly or indirectly, e.g., through gears, strap, non-contact magnetic drive, etc., into rotation. The threads 386 comprises an upstream face 388 and a downstream face 390, wherein the upstream face 388 contacts the extrudable material 220 forcing the extrudable material 220 downstream upon rotation of the conveyor screw 232/332.

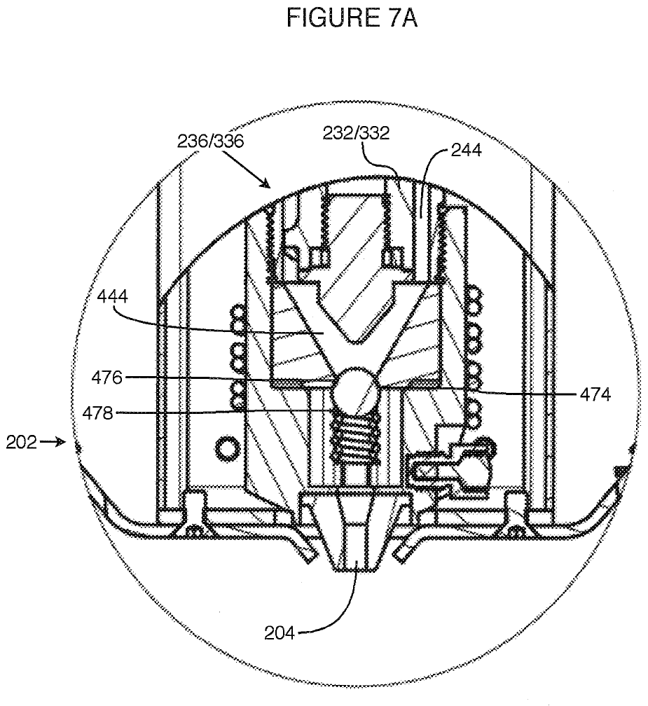

Not visible on FIG. 8, the conveyor screw 332 comprises a rotation axis, with the longitudinal hole 350 (see FIG. 6) being coaxial with the rotation axis. The longitudinal hole 350 extends over the length 380 of the conveyor screw 332, extending over sections of the conveyor screw 332 featuring no threads.

Further, the conveyor screw 232/332 has a shaft 378 defining a screw minor diameter 376. The conveyor screw 232/332 further has a screw major diameter 374 defined according to the edge 392 of the threads 386. According to any plan passing through the rotation axis, the surface of the screw minor diameter 376, the upstream face 388 of the thread 386, the corresponding surface of the inner bore 358 of the barrel 356 and the downstream face 390 of the neighbor thread 386 define together a conveying space 394 occupied by the extrudable material 220 conveyed by the conveyor screw 232/332. Thus, the conveying space 394 is characterized by the pitch 396 or distance between neighbor threads 386, the thread angle, the screw minor diameter 376 and the screw major diameter 374, the latter corresponding to or about the diameter of the inner bore 358.

According to the depicted embodiment, the threads 386 may comprise a single helicoidal thread extending in a continuous manner over a sub-length 381 of the conveyor screw 232/332.

The pitch 396 of the threads 386 may further be constant over the threaded portion of the conveyor screw 232/332.

The thread 386 may further have a constant thickness (distance between its upstream face 388 and its downstream face 390) regardless of the position of the thread along the length of the conveyor screw 232/332. The thread 386 may further has a constant thickness regardless of the extend of the thread 386 away from the shaft 378.

According to embodiments (not depicted), the thickness of the threads 386 vary as the threads 386 extend downstream (the thickness increasing) and/or away from the shaft 378 (the thickness decreasing).

According to other embodiments (not depicted), the threads 386 comprises a plurality of helicoidal threads. According to embodiments, one or all of the threads have a diameter matching the screw major diameter 374.

According to another embodiment (not depicted), the pitch 396 of the threads 386 varies, e.g., decreases, as the threads 386 extend downstream.

The shaft 378 further has a variation in its dimensions, the screw minor diameter 376 increasing as the featured section of the conveyor screw 232/332 gets closer to the downstream end 384 in order to decrease the conveying space as the material travel downstream.

Further, the conveyor screw 232/332 comprises a shoulder 372 at the upstream limit of the threaded portion of the conveyor screw 232/332. The shoulder 372 has an outer diameter 370 equal or greater than the screw major diameter 374. The shoulder 372 prevents upstream flow of extrudable material 220.

Referring additionally to FIGS. 2 and 3, the barrel 356 has a variable diameter of inner bore 358, with the upstream portion of the inner bore 358 having a conical shape joining the downstream portion of the inner bore 358 at its smallest diameter. The upstream portion of the barrel 356 operates as a funnel for the feeding of the conveyor screw 232/332 with extrudable material 220 in solid state.

According to an embodiment, the shoulder 372 has a diameter about the diameter of the inner bore 358 resulting in the shoulder 372 abutting or almost abutting the inner bore 358 in the conical portion of the barrel 356.

The conveyor screw 232/332 has, at the upstream extremity, a driving engagement surface 368, a.k.a. a tangential face 368, adapted to engage with a driving mechanism (not shown) to drive the rotation of the conveyor screw 232/332. According to an embodiment, the tangential nature, opposed to axial, of the driving engagement surface 368 frees the upstream end 382 of the conveyor screw 232/332 for passage of the wire of reinforcement material 222 and operation of the cutting component 320 according to an embodiment as will be described below.

The conveyor screw 232/332, at the downstream end 384, comprises a conical head 366 extending from a downstream shaft 362 of smaller diameter than the screw shaft 378. The difference in diameters of the downstream shaft 378 versus the screw shaft 378 provides clearance for the extrudable material 220 to flow along the downstream shaft 378 and the conical head 366.

The conical head 366 of the conveyor screw 332 ends up with an aperture 364 resulting from the presence of the longitudinal hole 350 crossing longitudinally the conveyor screw 332.

It is worth noting that according to the nature of the longitudinal hole 350 being co-axial with the conveyor screw 332, and the conical shape of the conical head 366, the aperture 364 has a circular edge along a plan perpendicular to the rotation axis of the conveyor screw 332.

It is further worth noting that the reinforcement material 222 is insulated from contact with the extrudable material 220 along its path up to its exit through the aperture 364 of the conical head 366. Thus, heating of the extrudable material 220 in the conveying space 394 has limited effect on the temperature of the reinforcement material 222.

Referring now to FIG. 6, the cutting component 320 comprises a blade 322 mounted about the upstream end 382 of the conveyor screw 332 before the reinforcement material 222 entering the longitudinal hole 350. It is to be noted that the reinforcement material 222 consists in a continuous wire-type or tubular-type material before entering the longitudinal hole 350, and in lengths of queued sections of reinforcement material once in the longitudinal hole 350. The wire driving mechanism 324 (aka the reinforcement material driving mechanism) pushes the wire of reinforcement material 222 and thus the lengths of reinforcement material 222 to feed the extrusion process with cut lengths of reinforcement material 222.

Since the cutting component 320 cuts the reinforcement material 222 about the upstream end 338 of the conveyor screw 332, thereby the conduit 350 is filled with extrusion-size lengths of reinforcement material 222 in a queue fashion. Movement of the reinforcement material 222 is insured by at least one, and usually by a combination of a pushing force applied over the reinforcement material 222 at the upstream end 338 and a vacuum force sucking extrusion-size lengths of reinforcement material 222 downward at the downstream end 336.

According to an embodiment, the wire driving mechanism 324 comprises a pair of motorized or driven rollers 326 controlling the speed of the reinforcement material 222. According to an embodiment, one of the rollers 326 is driven by a motor while another is a passive roller maintaining pressure and driven by the displacement of the wire between the rollers 326.

According to an embodiment, the cutting component 320 and the wire driving mechanism 324 are driven independently from each other, thereby be able, by controlling them, to vary the lengths of the sections of reinforcement material 222 in queue in the longitudinal hole 350.

According to another embodiment, the cutting component 320 is a shearing mechanism cutting reinforcement material 222 about the nozzle 204.

It is worth noting that since the flow of extrudable material 220 and of reinforcement material 222 are driven independently from each other, one through the conveyor screw 232 and the other through a wire driving mechanism 324 (FIG. 6), the length of reinforcement material 222 to deposit with extrudable material 220 may be precisely controlled. Example of means to control comprise independent control of the speed of the material conveying mechanisms, and control of temperature and pressure exerted over the extrudable material 220. Depending on the length of the deposition to be performed, it may be advantageous to controllably vary the lengths in longer and shorted lengths of reinforcement material 222 to provide optimum reinforcement without the reinforcement material 222 tending to depart from the desired geometry by exceeding the length of the deposit or having difficulty to match the curves exerted during the depositions.

Further, since the reinforcement material 222 is mixed for a short period with the extrudable material 220, and the reinforcement material 222 being at least partially insulated from the heat used to melt the extrudable material 220 in the barrel 356, the present solution allows to operate with a variety of reinforcement materials 222 of variable sensibility to heat, including material of lower points of fusion than the extrudable material 220 that are able to resist to the heat for the short period during which the lengths of reinforcement material 222 are in contact with the extrudable material 220 in the nozzle 204.

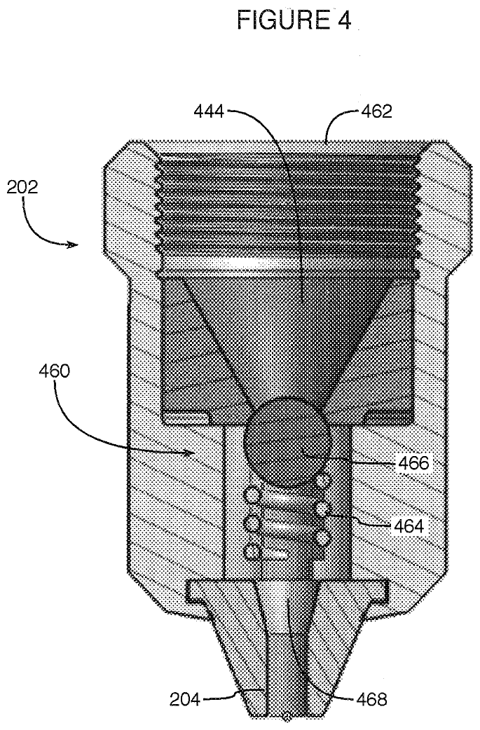

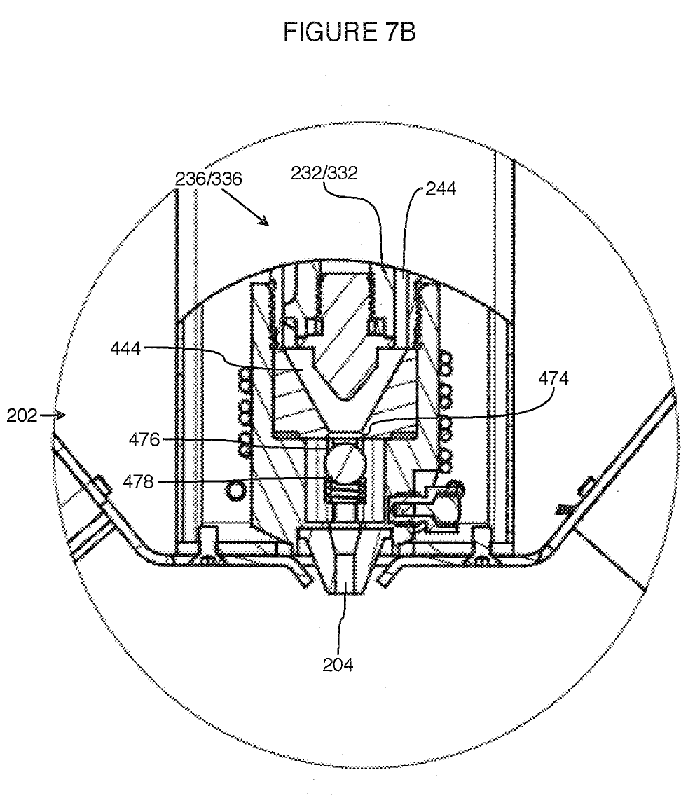

Now referring to FIG. 4 and FIGS. 7A-7B, the is depicted a cross-section of an extrusion head 202 as permanently or releasably mounted to the heating component 240 or barrel 356 about the downstream end 236/336 of the conveyor screw 232/332 (see FIGS. 2 and 3). The extrusion head 202, according to a non-limiting embodiment, is screwed to the heating component 240, providing a releasable mounting while fluidly connecting the passage 244 to channel 444 for the extrudable material 220 to flow from the inlet 462 to the nozzle 204.

According to an embodiment, the extrusion head 202 features a flow stopping assembly 460. The flow stopping assembly 460 comprises a plug 466 moveable between a no-flow position wherein the plug 466 hinders or blocks the flow of extrudable material 220 from the channel 444 preventing the flow to reach the nozzle 204, and a second position where the channel 444 is freed from at least part of the hindering provided by the plug 466.

The extrusion head 202 comprises a body comprising an inlet 462, a nozzle outlet 468 and a channel 444 fluidly connecting the nozzle outlet 468 to the inlet 462 for the flow of material to travel in a downstream flow direction from the inlet 462 to the nozzle outlet 468. The extrusion head 202 further comprises a plug 466 located in the channel 444, the plug 466 operable in a no-flow position (FIG. 7B, plug 466 biased upstream) blocking the flow of material between the inlet 462 to the nozzle outlet 468 and another position (FIG. 7B, plug 466 pushed downstream) allowing the flow of material from inlet 462 to the nozzle outlet 468. The extrusion head 202 further comprises a biasing means 464, such as a spring 464, pushing against the plug 466 against the flow direction, aka upstream-ward. Accordingly, a pressure against the plug 466 higher than a no-flow pressure results in the plug 466 leaving the no-flow position and thereby allow the flow of material to reach the nozzle outlet 468. The extrusion head 202 comprises a shoulder 474 abutted by the plug 466 when in the no-flow position, and thus stopping completely the flow therearound.

According to embodiments, the pressure of material upstream from the flow stopping assembly 460 is controlled at least partially by one of speed of rotation of the conveyor screw 232/332, feeding pressure of extrudable material 220 about the hopper, the direction of rotation of the conveyor screw 232/332, and displacement along the longitudinal direction of the conveyor screw 232/332 upstream-ward for decreasing pressure and downstream-ward for increasing pressure when stopping and starting flow of material.

According to an embodiment, the plug 466 is of a spherical, conical or cylindrical shape comprising a blocking surface 476 and a biased surface 478 where the plug 466 is contacted by the biasing means 464. The conveyor screw 232/332 generates a pressure in the conveying material which pushes the plug 466 downstream-ward against the biasing means 464.

According to an embodiment (not depicted), the conveyor screw 232 when mounted such to be able to move between a most upstream position and a most downstream position when respectively stopping and starting the flow of extrudable material 220 is adapted to contact the plug 466 in its most downstream position, therefore participating in pushing the plug 466 in the flow direction to thereby allow free downstream flow of material toward the nozzle outlet 468.

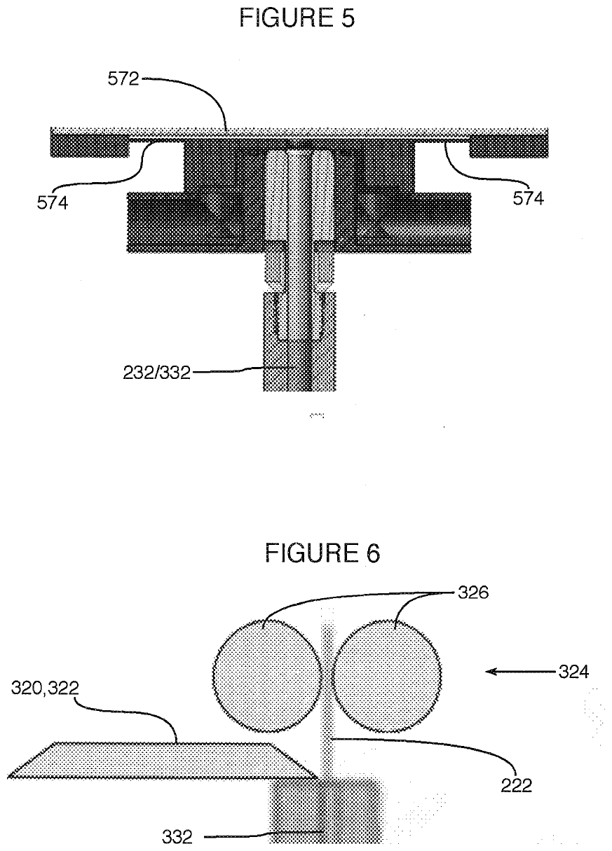

Referring now to FIG. 5, there is shown a cross-section view of the mounting of the upper end of the conveyor screw 232/332 according to an embodiment. The conveyor screw 232/332 is mounted to the frame 572 of the three-dimensional manufacturing apparatus 100. A driving mechanism (not shown) is operating to rotate the conveyor screw 232/332 and thus to forcedly convey extrudable material 220 towards the extrusion head 202. A sensor 574, mounted between the conveyor screw 232/332 and the frame 572 and mounted to one of them is adapted to sense forces parallel to the screw axis, or in other words detect, translate into signals and communicate these signals to the controller 106 (see FIG. 1).

According to an embodiment, the driving mechanism driving the rotation of the conveyor screw 232/332 is a motor, and more specifically a stepper, and according to a specific embodiment a Field Oriented Control (FOC) motor with an associated control board (with both the motor and the associated control board not depicted) adapted to provide information on torque applied by and speed of the FOC motor. The control board is adapted to provide signals indicative of at least one the position, aka angle of rotation, the torque and speed to the controller 106.

According to embodiments, the controller 106, using the available information (e.g., the sensed longitudinal force alone or in combination with one or more of the FOC speed and the FOC torque) from the sensor 574 and optionally the FOC motor, determines, based on an internal algorithm, at least one of resulting pressure and resulting force. In the present context, resulting pressure refers to pressure exerted by the extrudable material 220 in the passage 244 inside the heating component 240, aka the conveying space, and in the channel 444 in the extrusion head 202. In the present context, resulting force(s) refers to forces exerted by the extrudable material 220 over the conveyor screw 232/332 against rotation of the conveyor screw 232/332.

According to an embodiment, the sensor 574 is a strain gauge mounted to the frame 572.

While preferred embodiments have been described above and illustrated in the accompanying drawings, it will be evident to those skilled in the art that modifications may be made without departing from this disclosure. Such modifications are considered as possible variants comprised in the scope of the disclosure.

1. An apparatus for fabricating a three-dimensional object from deposition of layers made of extrudable material, wherein the apparatus comprises:
an extrusion assembly comprising:
a feeder adapted for conveying the extrudable material; and
a barrel comprising an inner bore, an upstream end and a downstream end; and
a screw rotatably mounted within the inner bore, comprising threads adapted for conveying, by the threads, the extrudable material located between the screw and the inner bore toward the downstream end; and
a sensor mounted to the extrusion assembly, the sensor measuring forces exerted by the screw for establishing at least one of a) extrusion force and b) extrusion pressure applied by the apparatus over the extrudable material.

2. The apparatus of claim 1, wherein the extrusion assembly further comprises a nozzle, mounted to the downstream end of the barrel, comprising an outlet, wherein the nozzle is adapted for concurrently dispensing, through the outlet, the extrudable material conveyed by the screw.

3. (canceled)

4. (canceled)

5. The apparatus of claim 1, further comprising an extrusion head comprising an inlet, an outlet and a channel fluidly connecting the inlet to the outlet whereby, when a flow of extrudable material is provided, the flow of extrudable material travels in a downstream direction.

6. The apparatus of claim 5, wherein the extrusion head further comprises a plug located in the channel, the plug operable in either one of: a) a no-flow position blocking the flow of material between the inlet and the outlet of the extrusion head; and b) another position allowing the flow of material from the inlet to the outlet of the extrusion head.

7. The apparatus of claim 6, wherein the extrusion head further comprises a biasing means pushing the plug against the downstream direction, wherein a pressure against the plug greater than a no-flow pressure counteracts against the biasing means resulting in the plug leaving the no-flow position and thereby allowing the flow of material to reach the outlet of the extrusion head.

8. The apparatus of claim 7, wherein the extrusion head is mounted to the extrusion assembly; and wherein the plug has a surface of a spherical shape which is pushed by the biasing means toward the extrusion assembly.

9. An extrusion assembly to be mounted to an apparatus adapted for making three-dimensional physical objects by depositing a plurality of layers of extrudable material, the extrusion assembly comprising:
a barrel comprising an inner bore, an upstream end and a downstream end;
a screw rotatably mounted within the inner bore, comprising threads, wherein the screw is adapted for conveying, by the threads, the extrudable material located between the screw and the inner bore toward the downstream end; and
a nozzle, mounted to the downstream end of the barrel, comprising an outlet, an inlet and a channel fluidly leading to the outlet, wherein the nozzle is adapted for dispensing in a downstream direction, through the channel and the outlet, the extrudable material conveyed by the screw, comprising:
a plug located in the channel, the plug operable in either one of: a) a no-flow position blocking a flow of material between the inlet and the outlet of the nozzle; and b) another position allowing the flow of material from the inlet to the outlet of the nozzle.

10. The extrusion assembly of claim 9, wherein the nozzle further comprises a biasing means pushing the plug against the downstream direction, wherein a pressure against the plug greater than a no-flow pressure counteracts against the biasing means resulting in the plug leaving the no-flow position and thereby allowing the flow of material to reach the outlet of the nozzle.

11. The extrusion assembly of claim 10, wherein the plug has a surface of a spherical shape which is pushed by the biasing means upstream-ward.

12. (canceled)

13. (canceled)

14. The extrusion assembly of claim 11, wherein the screw has a screw length and a threaded length, and wherein the threaded length is smaller than the screw length.

15. The extrusion assembly of claim 11, wherein the screw has an axis, a threaded length and a major diameter measured based on radial extent of the threads from the axis, and wherein the major diameter is constant over the threaded length.

16. The extrusion assembly of claim 11, wherein the screw has a threaded length, and wherein the threads have a thread angle that is constant over the threaded length.

17. The extrusion assembly of claim 11, wherein the screw has an axis, a threaded length, a shaft and a minor diameter measured based on radial extent of the shaft from the axis, and wherein the minor diameter increases over the threaded length as the shaft extends downstream.

18. The extrusion assembly of claim 11, wherein the screw has an axis, a shaft, a threaded length, and defines, in combination with the inner bore, a plurality of conveying spaces of an area on any plan comprising the axis; and wherein the area of a first one of the conveying spaces is smaller than the area of a second one of the conveying spaces with the first one of the conveying spaces being downstream to the second one of the conveying spaces.

19.-21. (canceled)

22. An extrusion assembly to be mounted to an apparatus adapted for making three-dimensional physical objects by depositing a plurality of layers of extrudable material, the extrusion assembly comprising:
a barrel comprising an inner bore, an upstream end and a downstream end;
a feeder mounted, at least in part, within the inner bore adapted for conveying the extrudable material, which is within the inner bore, toward the downstream end; and
a nozzle, mounted to the downstream end of the barrel, comprising an outlet, an inlet and a channel fluidly leading to the outlet, wherein the nozzle is adapted for dispensing in a downstream direction, through the channel and the outlet, the extrudable material conveyed by the feeder, comprising:
a plug located in the channel, the plug operable in either one of: a) a no-flow position blocking a flow of material between the inlet and the outlet of the nozzle; and b) another position allowing the flow of material from the inlet to the outlet of the nozzle.

23. The extrusion assembly of claim 22, wherein the nozzle further comprises a biasing means pushing the plug against the downstream direction, wherein a pressure against the plug greater than a no-flow pressure counteracts against the biasing means resulting in the plug leaving the no-flow position and thereby allowing the flow of material to reach the outlet of the nozzle.

24. The extrusion assembly of claim 23, wherein the plug has a surface of a spherical shape which is pushed by the biasing means upstream-ward.

25. The extrusion assembly of claim 9, further comprising a sensor for measuring forces exerted by the screw for establishing at least one of a) extrusion force and b) extrusion pressure applied by the apparatus over the extrudable material.

26. The extrusion assembly of claim 22, further comprising a sensor for measuring forces exerted by the feeder for establishing at least one of a) extrusion force and b) extrusion pressure applied by the apparatus over the extrudable material.

27. An extrusion head for an apparatus for fabricating three-dimensional objects using a flow of extrudable material, the extrusion head comprising:
a body comprising an inlet, a nozzle outlet and a channel fluidly connecting the nozzle outlet to the inlet for the flow of extrudable material to travel in a downstream direction from the inlet to the nozzle outlet;
a plug located in the channel, the plug operable in a no-flow position blocking the flow of material between the inlet to the nozzle outlet and another position allowing the flow of material from inlet to the nozzle outlet; and
a biasing means pushing against the plug against the downstream direction, wherein a pressure against the plug higher than a no-flow pressure results in the plug leaving the no-flow position and thereby allow the flow of material to reach the nozzle outlet.
